(19) United States
(12) Patent Application Publication
(10) Pub. No.: US 2025/0236495 A1
(43) Pub. Date: Jul. 24, 2025

(54) Wood Climbing and Load Raising and Lowering System, Tool and Method

(71) Applicant: Matt Cunningham, Ellis, KS (US)

(72) Inventor: Matt Cunningham, Ellis, KS (US)

(21) Appl. No.: 18/417,069

(22) Filed: Jan. 19, 2024

(51) Int. Cl. B66D 3/02

(52) U.S. Cl. CPC B66D 3/02; B66D 2700/023

(57) ABSTRACT

A wood climbing and load raising and lowering tool, system and method is disclosed. In some embodiments, the tool and system includes a support member having a first end, a second end, and a middle portion therebetween; a threaded spike connected to the first end of the support member; a handle connected to the second end of the support member; and a pulley detachably connected to the middle portion of the support member. In some embodiments the method includes the steps of providing a wood climbing and load raising and lowering tool; connecting the threaded spike of the wood climbing and load raising and lowering tool to a wood surface; connecting a rope to the pulley of the wood climbing and load raising and lowering tool; connecting a load to the rope; and raising and lowering the rope to raise and lower the load to a desired height.

### FIELD OF INVENTION

The invention is in the technical field of lightweight, small, portable, hand-held, wood climbing and load raising and lowering systems, tools, and methods. The invention is generally directed to systems, tools, and methods that are configured for use by a single person for climbing trees, wood poles, and the like, and for raising and lowering a load, such as tools and equipment, up or down to a desired height.

### BACKGROUND

Traditional climbing tools, such as ropes, pulleys, foot spikes, and ladders are known in the art. Unfortunately, however, such traditional climbing systems, tools and methods are not configured for efficiently climbing wood poles or trees and are often large, heavy, difficult to carry, cumbersome and complicated to safely use at height by a single person. For example, traditional climbing tools may require a rope to be tied or strapped around a person, tree, or pole and/or may require multiple tools, harnesses, specialized shoes, or other expensive or complicated equipment, which is bulky, heavy to carry, and time consuming to set-up, install, and then remove from the tree or pole once the climb is completed and the load is raised or lowered. Thus, decreasing their usefulness, particularly their usefulness by hunters and utility line workers, who require a simple, lightweight, small, portable, hand-held, system, tool and method that can be carried by hand or in a small backpack on foot and safely used by a single person to climb a tree or pole and raise or lower a load to a desired height and for use by the person in the tree or pole.

For example, hunters will often walk long distances with hunting equipment, such as a rifle and tree-stand, and then climb a tree to set up the tree stand at height for use by the hunter in hunting game from up above. Traditional, large, heavy, and cumbersome climbing and lifting equipment is not advantageous or efficient for use by hunters in such circumstances because such traditional equipment is too heavy to be carried on foot and is too cumbersome and complicated for use by a single person. Thus, hunters will often forego using such traditional equipment and climb the tree and lift the rifle, tree stand, and other equipment by hand or by using a simple rope. Unfortunately, however, climbing a tree by hand and lifting such equipment up the tree by hand or with a simple rope is difficult, cumbersome, and dangerous. Moreover, use of a simple rope to raise and lower equipment limits the amount and size of equipment that can be safely lifted by a single person up the tree. Traditional climbing tools are not sufficiently configured or designed for such purposes and hunters are unlikely to carry heavy and complicated tools when traveling by foot in the wild for use in a hunting blind located up in a tree.

Likewise, utility line workers often climb wooden utility poles and lift equipment up said poles to a desired height for making repairs, installations, or performing other work at height on the utility line. This work is dangerous and difficult to perform. Traditional climbing and lifting equipment is heavy, cumbersome, and is not advantageous or efficient for use by utility line workers, especially in circumstances where larger lifting and climbing equipment is not available or practical and where only a single person is needed or desired to perform the necessary repair, installation, or work.

To that end, it would be advantageous to provide an improved wood climbing system, tool, and method that overcomes these and other disadvantages of traditional wood climbing tools and systems, and which is lightweight, small, portable, hand-held, and capable of being safely used by only a single person to simultaneously climb a tree or pole and lift a load up the tree or pole to a desired height. The disclosed and claimed invention is configured to overcome the above-mentioned disadvantages and provide a safe, efficient, cost effective, and simple to use and operate tool, system and method. For example, the disclosed and claimed invention is configured to be used by a single person, such as a hunter, who may carry the invention in a backpack and on foot along with other hunting equipment, such as a rifle and tree stand, and is configured to be used by the hunter to both climb a tree and raise the hunting equipment up the tree to a desired height so that the hunter can safely and securely set up and use the hunting equipment at height in the tree and without help from any other persons or use of any other equipment. Similarly, for example, the disclosed and claimed invention is configured to be used by a utility line worker to climb a wooden utility pole and raise and lower equipment up the utility pole to a desired height. Thus, providing numerous safety, cost, and efficiency advantages over heavy, complicated, and cumbersome traditional wood climbing tools, systems and methods.

The improved wood climbing and load raising and lowering tool and system generally includes a support member having a first end, a second end, and a middle portion therebetween. The improved wood climbing and load raising and lowering tool and system includes a threaded spike connected to the first end of the support member; a handle connected to the second end of the support member; and a pulley detachably connected to the middle portion of the support member. In some embodiments the improved wood climbing and load raising and lowering tool and system also includes a rotatable pulley connector for detachably connecting the pulley thereto such that the pulley may rotate about the support member thereby permitting the pulley to be movable and rotatable while the improved wood climbing and load raising and lowering tool and system is detachably connected to wood, such as a tree. The improved wood climbing and load raising and lowering method generally includes the steps of (a) providing a wood climbing and load raising and lowering tool; (b) connecting the threaded spike of the wood climbing and load raising and lowering tool to a wood surface; (c) connecting a rope to the pulley of the wood climbing and load raising and lowering tool; (d) connecting a load to the rope; and (e) pulling or releasing the rope through the pulley to raise or lower the load to the desired height.

The improved wood climbing and load raising and lowering tool, system and method is configured to be light weight, reusable, modular, and comprised of interchangeable component parts that can be selectively changed, modified, attached, or detached to one another by a user, on the fly and in real-time, for repair, cleaning, modification, or storage and so that different component parts may be detachably connected thereto in a variety of different and custom configurations and orientations. Further, the pulley of the improved wood climbing and load raising and lowering tools, system and method is capable of selectively rotating about the support member and being locked in place on the support member or being left unlocked to rotate freely around the support member during use. Thus, providing a user with maximum flexibility when using the improved wood climbing and load raising and lowering tool, system, and method.

Because the pulley is capable of selectively rotating about the support member, the improved wood climbing and load raising and lowering tool, system and method provides unexpected benefits and advantages over traditional climbing tools. Because the pulley of the improved wood climbing and load raising and lowering tool and system is capable of rotating about the support member the direction of the rope may be changed, angled, or adjusted on the fly, in real time and without use of complicated, heavy or cumbersome equipment. The angle of the pulley on the support member is important because during use in a tree for example, the pulley and rope may need be adjusted to go around tree limbs and other obstacles. Further, the angle of the pulley on the support member is important because the pulley is capable of rotating around the support member to stay in a fixed position while the support member and handle rotate to fix and insert the threaded spike to the wood. Thereby permitting the pulley position to be fixed while the improved wood climbing and load raising and lowering tool and system is hand turned to fix the threaded spike into the wood. Alternatively, the pulley may be locked in place on the support member and rotate along with the support member.

These features permit a single person to safely use the tool and system at height or while carrying other equipment. Thus, providing increased and unexpected safety and efficiency advantages that traditional tools and systems which are more cumbersome to operate and control at height do not provide. The improved tool, system and method is flexible, efficient, lightweight, adaptable, and customizable, in real time on the fly, for use in a variety of conditions. The different and connectable component parts of the tool and system are configured to be provided as a kit or modular system such that the component parts may be replaced, changed, reused, rearranged, or modified by the user in real time and on the fly. These advantages are unexpected and provide numerous benefits over traditional wood climbing tools.

### SUMMARY OF THE INVENTION

The inventive concepts disclosed and claimed herein generally relate to an improved, unique, and non-obvious wood climbing system, tool, and method. The disclosed and claimed invention is generally directed to a lightweight, small, portable, hand-held wood climbing tool, system and method that is capable of being carried and used by a single person to both climb a tree or pole and lift a load to a desired height in the tree or pole. an improved wood climbing system, tool, and method that overcomes these and other disadvantages of traditional wood climbing tools and systems, and which is lightweight, small, portable, hand-held, and capable of being safely used by only a single person to simultaneously climb a tree or pole and lift a load up the tree or pole to a desired height.

For example, the invention is configured to be used by a single person, such as a hunter, who may carry the invention in a backpack and on foot along with other hunting equipment, such as a rifle and tree stand, and is configured to be used by the hunter to both climb a tree and raise the hunting equipment up the tree to a desired height so that the hunter can safely and securely set up and use the hunting equipment at height in the tree and without help from any other persons or use of any other equipment. Similarly, the invention is configured to be used by a utility line worker, for example, to climb a wooden utility pole and raise and lower equipment up the utility pole to a desired height. Thus, providing safety, cost and efficiency advantages over traditional wood climbing tools, systems and methods.

The improved wood climbing and load raising and lowering tool and system generally includes a support member having a first end, a second end, and a middle portion therebetween. The improved tool and system include a threaded spike connected to the first end of the support member; a handle connected to the second end of the support member; and a pulley detachably connected to the middle portion of the support member. In some embodiments the improved wood climbing and load raising and lowering tool and system also includes a rotatable pulley connector for detachably connecting the pulley thereto such that the pulley may rotate about the support member thereby permitting the pulley to be movable, adjustable, and rotatable while the improved wood climbing and load raising and lowering tool and system is detachably connected to wood, such as a tree. The method generally includes the steps of providing a wood climbing and load raising and lowering tool; connecting the threaded spike of the wood climbing and load raising and lowering tool to a wood surface; connecting a rope to the pulley of the wood climbing and load raising and lowering tool; and connecting a load to the rope.

The improved wood climbing and load raising and lowering tool, system and method is configured to be light weight, reusable, modular, and comprised of interchangeable component parts that can be selectively changed, modified, attached, or detached by a user, on the fly and in real-time, for repair, cleaning, modification, storage or so that different component parts may be detachably connected thereto. Further, the pulley of the improved wood climbing and load raising and lowering tools, system and method is capable of selectively rotating about the support member and being locked in place on the support member or being left unlocked to rotate freely around the support member during use. Thus, providing a user with maximum flexibility when using the improved wood climbing and load raising and lowering tools, system, and method. Because the pulley is capable of selectively rotating about the support member, the improved wood climbing and load raising and lowering tool, system and method provides unexpected benefits and advantages over traditional climbing tools. Further, because the pulley is capable of rotating about the support member the direction of the rope may be changed, angled, or adjusted on the fly, in real time and without use of complicated, heavy or cumbersome equipment. The angle of the pulley is important because during use in a tree for example, the pulley and rope may need be adjusted to go around tree limbs and other obstacles. The improved tool, system and method is flexible, efficient, lightweight, adaptable to a variety of conditions and is formed from a variety of detachably connected component parts and materials that may be reused, rearranged, or modified by the user in real time and on the fly.

The system, tool, and method generally includes: a support member having a first end, a second end, and a middle portion therebetween; a threaded spike connected to the first end of the support member; a handle connected to the second end of the support member; and a pulley detachably connected to the middle portion of the support member. In some embodiments a wood climbing and load raising and lowering system configured for climbing a wood surface and raising and lowering a load is disclosed. The wood climbing and load raising and lowering system includes: a support member having a first end, a second end, and a middle portion. The middle portion having a first ledge and a second ledge thereon. The first ledge and the second ledge define an area of the support member therebetween for securely detachably connecting a rotatable pulley connector thereto. The wood climbing and load raising and lowering system further includes a threaded spike detachably connected to the first end of the support member. The threaded spike is for detachably connecting the support member to a wood surface. A handle is detachably connected to the second end of the support member. The handle is positioned perpendicular to the support member, such that in use, the handle may be turned by hand to screw the threaded spike into the wood surface to detachably connect the wood climbing and load raising and lowering system to the wood surface. A rotatable pulley connector for detachably connecting a pulley. The rotatable pulley connector is rotatably connected to the support member between the first ledge and the second ledge of the support member. The rotatable pulley connector is configured to rotate around the support member. The wood climbing and load raising and lowering system further includes a pulley detachably connected to the rotatable pulley connector. The pulley is configured for receiving a rope therethrough and for raising and lowering the load. The pulley changes the direction of a force to lift the load or lower the load and may include a grooved wheel in which a rope runs through. The rope is for detachably connecting the load and raising and lowering the load detachably connected to the rope through the pulley.

In some embodiments, the wood climbing and load raising and lowering system further includes a rope detachably connected to the pulley. Further, in some embodiments the wood climbing and load raising and lowering system includes a load detachably connected to the rope. In some embodiments, the load is hunting equipment while in other embodiments the load is utility line equipment or tools for example. In some embodiments, the support member is a cylindrical rod while in some embodiments the handle is a hand crank. Further, in some embodiments the handle further includes an ergonomic grip.

A method of climbing a wood surface and raising and lowering equipment is also disclosed. The method includes the steps of: (a) providing a wood climbing and load raising and lowering tool. The wood climbing and load raising and lowering tool includes: a support member having a first end, a second end, and a middle portion therebetween; a threaded spike connected to the first end of the support member; a handle connected to the second end of the support member; and a pulley detachably connected to the middle portion of the support member. The method further includes the steps of: (b) connecting the threaded spike of the wood climbing and load raising and lowering tool to a wood surface; (c) connecting a rope to the pulley of the wood climbing and load raising and lowering tool; and (d) connecting a load to the rope. In some embodiments, the method further includes the step of: (e) pulling or releasing the rope upward or downward by hand to raise or lower the load to a desired height.

It is to such an improved wood climbing and load raising and lowering system, tool, and to methods of using thereof that exemplary embodiments of the inventive concepts disclosed and claimed herein are directed.

### BRIEF DESCRIPTION OF THE SEVERAL VIEWS OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings, and appendices. In the drawings:

FIG. 1 is a side perspective view of the wood climbing and load raising and lowering tool (100) according to the inventive concepts disclosed herein.

FIG. 2 is a side perspective view of the wood climbing and load raising and lowering system (200) according to the inventive concepts disclosed herein.

FIG. 3 is a perspective view of the wood climbing and load raising and lowering system (200) in use by a user according to the inventive concepts disclosed herein.

FIG. 4 is a diagram of the wood climbing and load raising and lowering method (300) according to the inventive concepts disclosed herein.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangements of the components or steps or methodologies set forth in the following description or illustrated in the drawings. The inventive concepts disclosed herein are capable of other embodiments or of being practiced or carried out in various ways. Also, it is to be understood that the phraseology and terminology employed herein is for the purpose of description and should not be regarded as limiting the inventive concepts claimed herein in any way.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, well-known features have not been described in detail to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

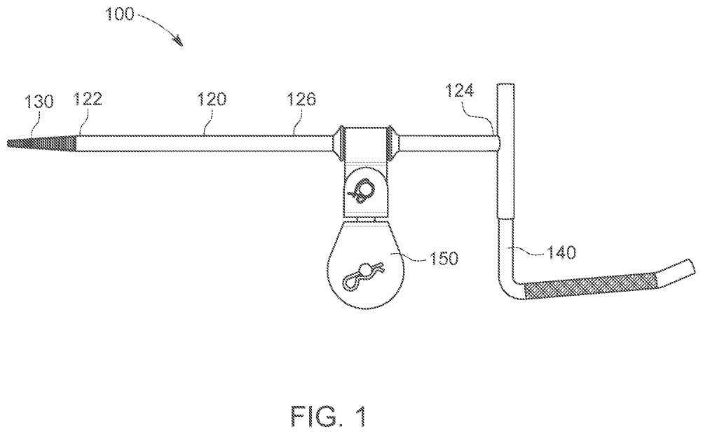

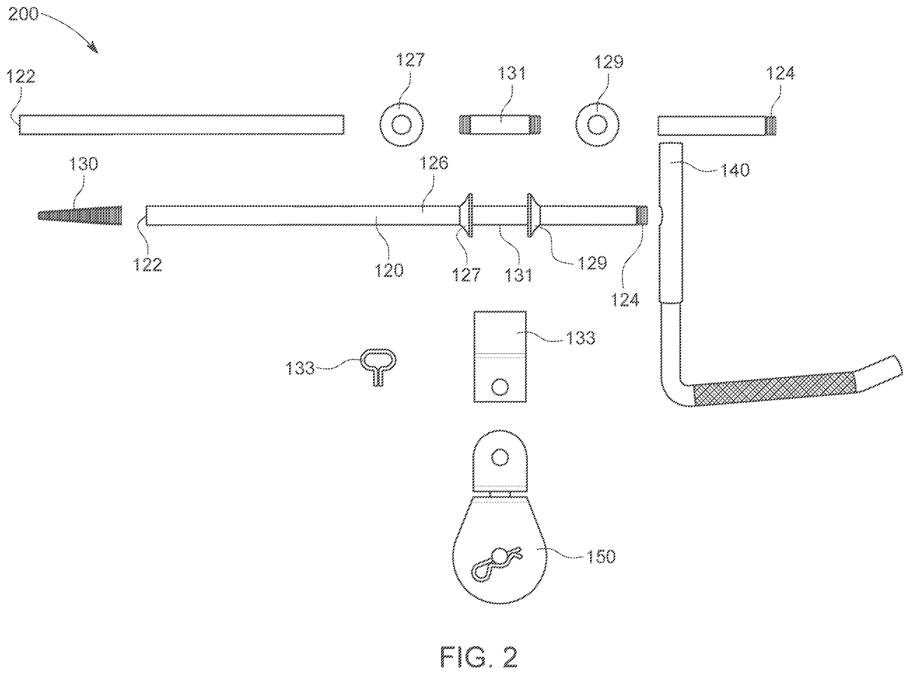

Referring now to FIGS. 1-4, shown therein are perspective views of embodiments of a wood climbing and load raising and lowering tool (100), a wood climbing and load raising and lowering system (200), and a wood climbing and load raising and lowering method (300) in accordance with the inventive concepts disclosed and claimed herein. The wood climbing and load raising and lowering tool (100) includes a support member (120) having a first end (122), a second end (124), and a middle portion (126) therebetween. The wood climbing and load raising and lowering tool (100) further includes a threaded spike (130) connected to the first end (122) of the support member (120); a handle (140) connected to the second end (124) of the support member (120); and a pulley (150) detachably connected to the middle portion (126) of the support member (120).

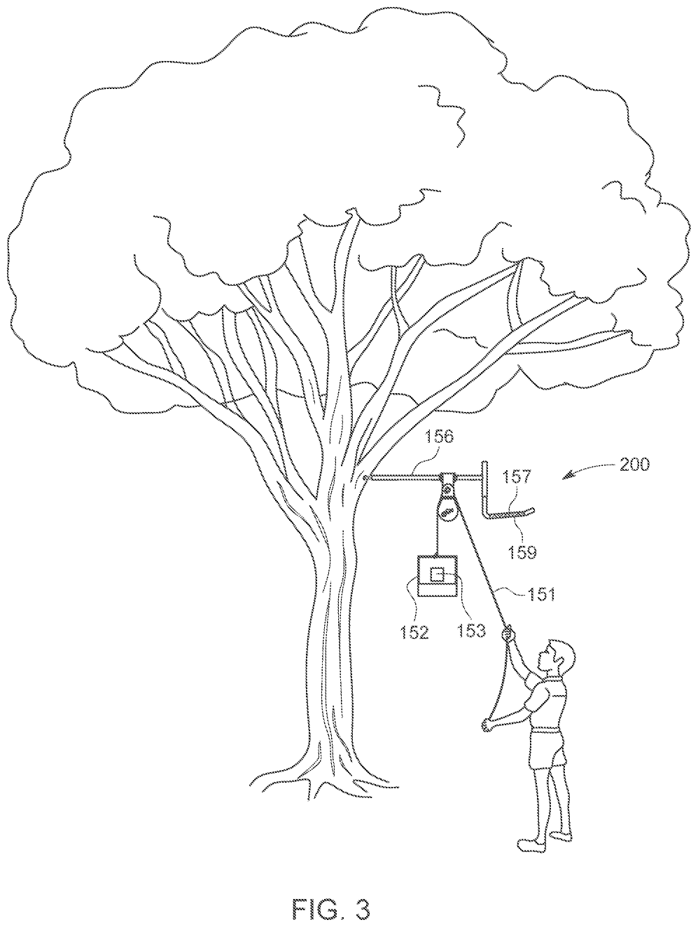

The wood climbing and load raising and lowering system (200) is configured for climbing a wood surface and raising and lowering a load. The wood climbing and load raising and lowering system (200) includes a support member (120) having a first end (122), a second end (124), and a middle portion (126). The middle portion (126) having a first ledge (127) and a second ledge (129) thereon. The first ledge (127) and the second ledge (129) defining an area (131) of the support member (120) therebetween for securely detachably connecting a rotatable pulley connector (133) thereto. The wood climbing and load raising and lowering system (200) further includes a threaded spike (130) detachably connected to the first end (122) of the support member (120). The threaded spike (130) for detachably connecting the support member (120) to a wood surface such as a tree (as shown in FIG. 3 for example) or post. The wood climbing and load raising and lowering system (200) further includes a handle (140) detachably connected to the second end (124) of the support member (120). The handle (140) positioned perpendicular to the support member (120) such that in use, the handle (140) may be turned by hand to screw the threaded spike (130) into the wood surface (103) to detachably connect the wood climbing and load raising and lowering system (200) to the wood surface.

The wood climbing and load raising and lowering system (200) further includes a rotatable pulley connector (133) for detachably connecting a pulley (150). The rotatable pulley connector (133) rotatably connected to the support member (120) between the first ledge (127) and the second ledge (129) of the support member (120). The rotatable pulley connector (133) configured to rotate around the support member (120). The wood climbing and load raising and lowering system (200) further includes a pulley (150) detachably connected to the rotatable pulley connector (133). The pulley (150) configured for receiving a rope (151) therethrough. The rope (151) for raising and lowering a load (152) detachably connected to the rope (151).

In some embodiments, the wood climbing and load raising and lowering system (200) further includes a rope (151) detachably connected to the pulley (150). While in some embodiments, the wood climbing and load raising and lowering system (200) further comprising a load (152) detachably connected to the rope (151). In some embodiments, the load (152) is hunting equipment (153). Further, in some embodiments, the support member (120) is a cylindrical rod (156). In some embodiments the handle (140) is a hand crank (157) while in some embodiments the handle (140) further comprises an ergonomic grip (159).

The wood climbing and load raising and lowering tool (100) and the wood climbing and load raising and lowering system (200) may be constructed from any material of sufficient strength necessary to maintain the structural integrity of the tool (100) and the system (200) and which is sufficiently lightweight, durable and capable of being used to raise and lower a load and to be fixed and inserted into wood, such as a tree or utility pole. The wood climbing and load raising and lowering tool (100) and the wood climbing and load raising and lowering system (200) may be formed from an integral piece of material or alternatively constructed from a variety of different component parts made from a variety of different materials and configured to be detachably connected to each other by screws, bolts, pins, threads, latches, adhesives, and the like. For example, in some embodiments the wood climbing and load raising and lowering tool (100) and system (200) may each be constructed from a unitary piece of aluminum, steel, or plastic; while in other embodiments each of the wood climbing and load raising and lowering tool (100) and system (200) may have certain component parts constructed from aluminum, such as the support member and threaded spike, while other component parts may be constructed from plastic, such as the pulley and handle, for example. The wood climbing and load raising and lowering tool (100) may be constructed from non-metals such as plastics, polycarbonate, impact resistant nylon, carbon fiber, polymers, resins, ceramics, composite materials, or metals such as alloys, steel, aluminum, titanium, combinations thereof and the like.

The wood climbing and load raising and lowering tool (100) and system (200) is shown as having a substantially cylindrical shape. It should be noted however that the wood climbing and load raising and lowering tool (100) and system (200) may be constructed in any desired shape, including a rectangular, circular, triangular, or square shape for example. Further, each of the component parts of the wood climbing and load raising and lowering tool (100) and system (200) may be of the same or different shape, including each of the support member (120), threaded spike (130), pulley (150), and handle (140). For example, in some embodiments, the support member (120) may be substantially flat and rectangular, while the threaded spike (130) is substantially cylindrical. Further, the handle (140) may be configured to be a hand crank, lever, automatic or electronic crank, and the ergonomic grip (159) may be constructed in a variety of different shapes and sizes, for example.

It is contemplated that in some embodiments a user will select from a variety of different sized, shaped, and dimensioned component parts of the wood climbing and load raising and lowering tool (100) and system (200), including the support member (130), pulley (150), and/or threaded spike (130), for example. The size, shape, and dimensions of each component part of the wood climbing and load raising and lowering tool (100) and system (200) may be selected from a variety of different sized and shaped component parts. In use, a user may, in real time, and on the fly, select from a variety of different sized, shaped, and dimensioned component parts and select a desired configuration of component parts and detachably connect the desired size, shape and configuration for optimal use for that user. For example, some users may desire a longer support member (120) or may desire the support member (120) to be wider or substantially flat or square or to have treads, ribs, or grip so that the support member (120) may also be used as a step for the foot of a user when climbing the tree or pole, for example.

Likewise, depending upon the load to be raised and lowered and the size of rope to be used, the size and shape of the pulley (150) may be varied to accommodate heavier or lighter loads for example. In this way, a user may selectively create a customized wood climbing and load raising and lowering tool (100) and system (200) in real time and on the fly based on the size of the user, the desired height and type of wood to be climbed, the size, shape and weight of the load to be raised and lowered, and the distance to be traveled while carrying the wood climbing and load raising and lowering tool (100) and system (200), such as for example, during a hunting trip where the user is going to carry the wood climbing and load raising and lowering tool (100) and system (200) in a backpack or the like before being able to use the wood climbing and load raising and lowering tool (100) and system (200). Similarly, the wood climbing and load raising and lowering tool (100) and system (200) is configured to be detachably connected to be stored in a backpack and/or may be extended or retracted, to increase or decrease the size of the wood climbing and load raising and lowering tool (100) and system (200) for storage (retracted position) and extended and locked into place via locking mechanism located on the wood climbing and load raising and lowering tool (100) and system (200).

In some embodiments, the wood climbing and load raising and lowering tool (100) and system (200), including each of its component parts, may have additional bracing, ribs, grip, or other structural support for increased strength and to enable the support member (120) of the wood climbing and load raising and lowering tool (100) and system (200) to also be used a foot support for climbing the tree or pole. For example, the support member (130) may include ridges, ribs, bracing structures, pins layered structural components within the structure, or other components configured to increase the grip when used as a foot support and to increase the structural strength, durability or flexibility of the wood climbing and load raising and lowering tool (100) and system (200) depending upon the size and shape of the user, the size, shape and weight of the load, and the size, shape and configuration of the tree or pole to be climbed.

In some embodiments, the dimensions of the wood climbing and load raising and lowering tool (100) and system (200), including the support member (120), threaded spike (130), handle (140), and pulley (150) is configured to be in a range between 6-24 inches, preferably between 6-12 inches, in length. Further, the wood climbing and load raising and lowering tool (100) and system (200) is configured to be slender in width, such as a rod, but in other embodiments may be wider in width or substantially flat, to accommodate different sized and shaped users and loads, for example, and so that the support member (120) may be used as a foot support for climbing.

In some embodiments, the wood climbing and load raising and lowering tool (100) and system (200), includes a support member (120) having a first end (122), a second end (124), and a middle portion (126). The middle portion (126) having a first ledge (127) and a second ledge (129) thereon. The first ledge (127) and the second ledge (129) define an area (131) of the support member (120) therebetween for securely detachably connecting a rotatable pulley connector (133) thereto. The first ledge (127) and the second ledge (129) may be any shape sufficient to selectively hold the pulley connector (133) in place on the support member (120). The distance between the first ledge (127) and second ledge (129) may also be increased or decreased depending upon the desired size of the pulley (150) and pulley connector (133) to be used and the size and shape of the load to be lifted. The first ledge (127) and the second ledge (129) may be slidably engaged with the support member (120) so that the dimensions can be adjusted, in real time and on the fly by a user. The rotatable pulley connector (133) rotatably connected to the support member (120) between the first ledge (127) and the second ledge (129) of the support member (120). The rotatable pulley connector (133) configured to rotate around the support member (120). In some embodiments, the rotatable pulley connector (133) has an opening therethrough so that the support member (120) is inserted through the opening of the rotatable pulley connector (133). In this way, the rotatable pulley connector (133) rotates about the support member (120) and is locked or secured in place by the first ledge (127) and the second ledge (129), which provide a structural barrier to keep the rotatable pulley connector (133) located in place on the support member (120) at a certain distance between the first end (122) and the second end (124) of the support member (120).

The pulley (150) is detachably connected to the rotatable pulley connector (133) in an adjustable but fixed position such that when the rotatable pulley connector rotates about the support member (120) the pulley (150) also rotates around the support member (120). Different sized and shaped pulley (150) may be detachably connected to the rotatable pulley connector (133) and the rotatable pulley connector (133) may have different shapes and sizes depending upon the load to be raised and lowered. Moreover, in some embodiments, a locking pin, bar, or other mechanism may be used to slidably engage by hand a locking pin to selectively lock and unlock the rotatable pulley connector (133) on the support member (120). In this way, the rotatable pulley connector (133) and pulley (150) may be selectively locked in a specific orientation on the support member (120) and selectively unlocked or allowed to swivel or rotate around the support member (120).

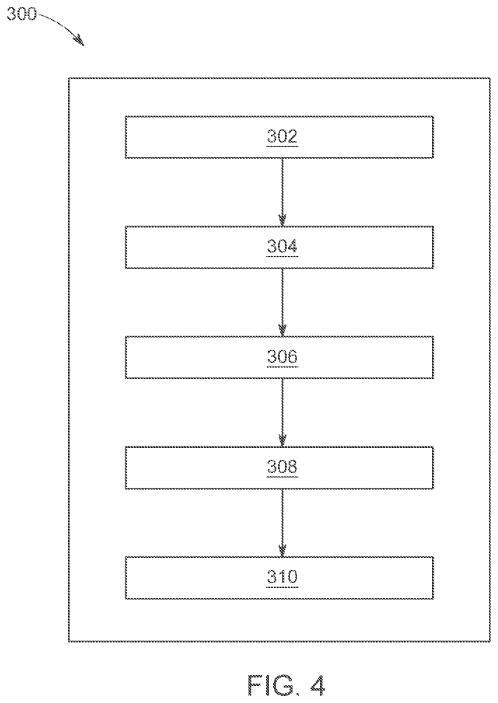

Referring now to FIG. 4, shown therein is a diagram depicting a method (300) of climbing a wood surface and raising and lowering equipment. The method (300) includes the steps of: (a) providing (302) a wood climbing and load raising and lowering tool (100) as described above. The wood climbing and load raising and lowering tool (100) includes a support member (120) having a first end (122), a second end (124), and a middle portion (126) therebetween. The wood climbing and load raising and lowering tool (100) includes a threaded spike (130) connected to the first end (122) of the support member (120); a handle (140) connected to the second end (124) of the support member (120); and a pulley (150) detachably connected to the middle portion (126) of the support member (120). The method (300) further includes the steps of: (b) connecting (304) the threaded spike (130) of the wood climbing and load raising and lowering tool (100) to a wood surface (103); (c) connecting (306) a rope (151) to the pulley (150) of the wood climbing and load raising and lowering tool (100); and (d) connecting (308) a load (152) to the rope (151). In some embodiments, the method (300) further includes the step of: pulling (310) the rope (151) upward or downward by hand to raise or lower the load (152) to a desired height.

In use, the wood climbing and load raising and lowering tool (100), system (200) and method (300) may be configured to be detachably connected by a user based upon a selection of available component parts in various sizes and dimensions and then stored in a bag or kit and carried. Alternatively, the wood climbing and load raising and lowering tool (100), system (200) and method (300) may be pre-assembled by the user or pre-assembled in a package for sale and then uses by the user. Once assembled and ready for use, a user connects the threaded spike (130) of the wood climbing and load raising and lowering tool (100) to a wood surface (103) by inserting the threaded spike (130) into the wood. The threaded spike (130) may be twisted by hand using the handle to insert the threaded spike into the wood at a desired distance and to secure the wood climbing and load raising and lowering tool (100) and system (200) to the wood for use. In some embodiments the handle (140) is a crank which is capable of manually turning the threaded spike (130) into the wood; while in other embodiments the handle (140) may be a lever, pull-trigger, or other mechanical device for automatically, electronically, or manually turning the threaded spike (130) into the wood to secure it in position. Likewise, the handle (140) may be ergonomic in design, may have additional padding, additional support, additional grip, and may be formed in various configurations designed for comfort. Once the threaded spike (130) is inserted into the wood, a rope, such as rope (151), is connected to the pulley (150). It should be understood that the rope (151) may be connected prior to insertion of the threaded spike (130) into the wood or after, depending upon the desired use and desired load to be raised and lowered. The load, such as load (152) may be connected to one end of the rope by any means known in the art, including knots, ties, carabiners, locking mechanisms, loops, and the like for example. Once the load is connected, it may then be pulled up or lowered down by the user using the pulley to a desired height.

It should be understood that each component part of the wood climbing and load raising and lowering tool (100) and system (200) and method (300) may be detachably connected to one another, in any combination, to form different orientations, different sizes, and different combinations of component parts as desired by the user. For example, one support member (120) may be detachably connected to a second or third support member (120) to lengthen the tool (100) and system (200); or a “Y” or “L” shaped connector, or any other type of connector, may be used to have two threaded spike (130) connected to a single support member (120) on opposite ends or both on one end using a “Y” shaped connector, for example. In this way, the tool (100) and system (200) may be selectively configured by a user for a variety of uses where obstacles such as tree limbs, utility lines, and the like may require changes in direction or orientation in relation to the tree or wood pole or where the size or configuration of the load to be raised or lowered necessitates. Various shaped connectors may be used to connect component parts and change the direction, orientation, and configuration of the tool (100) and system (200).

In some embodiments the wood climbing and load raising and lowering tool (100) and system (200) and method (300) may also include electronic components and parts, including one or more computer, display screen, wires, and receivers and transmitters for transmitting and receiving electronic transmissions, communications, RFID information, and data, including data and information via the world wide web over a wireless communication network, including Wi-Fi, and the internet or intranet. In some embodiments the wood climbing and load raising and lowering tool (100) and system (200) and method (300) is automated and the insertion of the threaded spike into the wood may be controlled automatically. Moreover, in some embodiments the wood climbing and load raising and lowering tool (100) and system (200) and method (300) may include additional electronic component tools and parts, including, for example, a compass, step-counter, GPS location tracker, cellular phone, display screen, and various other electronic components for viewing, displaying, tracking, transmitting, and receiving data, communications, and information. The type of information sent and received may be customized for hunting applications and/or for utility line work applications, including sending and receiving real time information related thereto between and among users and between and among computers, including remote computers and hand-held electronic devices. For example, GPS data, information regarding status of repairs on a utility line, location of game being hunted, and/or other data and information for recording, tracking and monitoring various aspects of a hunting session and utility line work for example.

It is to be appreciated that embodiments of the inventive concepts disclosed herein may be shipped fully or partially assembled, or fully or partially disassembled in the form of a kit, as will be readily appreciated by persons of ordinary skill in the art having the benefit of the instant disclosure.

From the above description, it is clear that the inventive concepts disclosed herein are adapted to carry out the objects and to attain the advantages mentioned herein as well as those inherent in the inventive concepts disclosed herein. While exemplary embodiments of the inventive concepts disclosed herein have been described for purposes of this disclosure, it will be understood that numerous changes may be made which will readily suggest themselves to those skilled in the art and which are accomplished within the broad scope of the inventive concepts disclosed herein and defined by the appended claims.

What is claimed:

1. A wood climbing and load raising and lowering tool comprising:
a support member having a first end, a second end, and a middle portion therebetween;
a threaded spike connected to the first end of the support member;
a handle connected to the second end of the support member; and
a pulley detachably connected to the middle portion of the support member.

2. A wood climbing and load raising and lowering system, configured for climbing a wood surface and raising and lowering a load, the wood climbing and load raising and lowering system comprising:
a support member having a first end, a second end, and a middle portion, the middle portion having a first ledge and a second ledge thereon, the first ledge and the second ledge defining an area of the support member therebetween for securely detachably connecting a rotatable pulley connector thereto;
a threaded spike detachably connected to the first end of the support member, the threaded spike for detachably connecting the support member to a wood surface;
a handle detachably connected to the second end of the support member, the handle positioned perpendicular to the support member such that in use, the handle may be turned by hand to screw the threaded spike into the wood surface to detachably connect the wood climbing and load raising and lowering system to the wood surface;
a rotatable pulley connector for detachably connecting a pulley, the rotatable pulley connector rotatably connected to the support member between the first ledge and the second ledge of the support member, the rotatable pulley connector configured to rotate around the support member; and
a pulley detachably connected to the rotatable pulley connector, the pulley configured for receiving a rope therethrough, the rope for raising and lowering a load detachably connected to the rope.

3. The wood climbing and load raising and lowering system of claim 2 further comprising a rope detachably connected to the pulley.

4. The wood climbing and load raising and lowering system of claim 3 further comprising a load detachably connected to the rope.

5. The wood climbing and load raising and lowering system of claim 4 wherein the load is hunting equipment.

6. The wood climbing and load raising and lowering system of claim 2 wherein the support member is a cylindrical rod.

7. The wood climbing and load raising and lowering system of claim 2 wherein the handle is a hand crank.

8. The wood climbing and load raising and lowering system of claim 2 wherein the handle further comprises an ergonomic grip.

9. A method of climbing a wood surface and raising and lowering equipment, the method comprising the steps of:
providing a wood climbing and load raising and lowering tool comprising:
a support member having a first end, a second end, and a middle portion therebetween;
a threaded spike connected to the first end of the support member;
a handle connected to the second end of the support member; and
a pulley detachably connected to the middle portion of the support member;
connecting the threaded spike of the wood climbing and load raising and lowering tool to a wood surface;
connecting a rope to the pulley of the wood climbing and load raising and lowering tool; and
connecting a load to the rope.

10. The method of claim 9 further comprising the step of:
pulling the rope upward by hand to raise the load to a desired height.
